(19) United States
(12) Patent Application Publication
(10) Pub. No.: US 2024/0296240 A1
(43) Pub. Date: Sep. 5, 2024

(54) SYSTEM, METHOD, AND COMPUTER PROGRAM FOR ENHANCING SOCIAL PLATFORM INFORMATION PROCESSING

(71) Applicant: RAKUTEN SYMPHONY SINGAPORE PTE. LTD., Singapore (SG)

(72) Inventors: Tomoya MURATA, Tokyo (JP); Sanyam MADAAN, Tokyo (JP)

(73) Assignee: RAKUTEN SYMPHONY SINGAPORE PTE. LTD., Singapore (SG)

(21) Appl. No.: 17/801,292

(22) PCT Filed: Jun. 21, 2022
(86) PCT No.: PCT/US2022/034242

§ 371 Date: Aug. 22, 2022

(51) Int. Cl. G06F 21/62; G06F 9/451

(52) U.S. Cl. CPC G06F 21/6218; G06F 9/451

(57) ABSTRACT

A method, system, apparatus, and computer-readable medium for enhancing social platform information processing is provided. The method, performed by at least one processor, includes receiving a selection from a first user for selecting social platform information extracted from a social platform, wherein the first user makes the selection before a plurality of second users. The method further includes presenting a first GUI to the first user, based on the selection, wherein the first GUI is configured to receive input information to perform an action and receiving a lock instruction from the first user, via the first GUI, and locking information associated with the selection based on the lock instruction. The method may also include disabling use of the locked information from the plurality of second users for a pre-set time period, wherein the first user is permitted to use the locked information during the pre-set time period.

### 1. FIELD

Apparatuses and methods consistent with example embodiments of the present disclosure relate to processing information from a social platform. The processing may trigger an action (e.g., creating a ticket) to be handled by one or more system users. Information relating to an action, such as a ticket, being handled by a system user may be locked/unlocked.

### 2. DESCRIPTION OF RELATED ART

In related art, automatically preventing another system user from accessing social platform information (e.g., a tweet) is suggested. However, the prevention is done by the system and is not flexible. Specifically, whenever the system detects that a system user is working on a particular social platform information and/or using the particular social platform information, the system will always block other users from accessing/working on the particular social platform information. As such, multiple system users cannot access the particular social platform information at the same time.

Other system users may want to create a ticket on the social platform information that is in use for different reasons or create a ticket regarding different issues. However, in a related art, the other system users cannot see the information of the system user who is working on the particular social platform information. Thus, the other system users cannot clearly know whether or not the system user is working on the social platform information for addressing the same or different issue. Further, a system user may be working on a social platform information but does not complete the work/ticket for an extended period of time (e.g., he has forgot that he is working on the social platform information, etc.). In that case, other system users cannot work on the same social platform information until after the first user has completed the ticket.

This method of preventing another system user from accessing a particular social platform information is not flexible and does not provide other system users with the ability to view, edit, and/or address other issues relating to the particular social platform information.

### SUMMARY

According to embodiments, methods are provided for enhancing information processing by providing locking/unlocking features to, for example, lock/unlock information that is being worked on.

According to embodiments, a method, performed by at least one processor of a computing device, for enhancing social platform information processing, includes: receiving a selection from a first user for selecting social platform information extracted from a social platform, wherein the first user makes the selection before a plurality of second users; presenting a first GUI to the first user, based on the selection, wherein the first GUI is configured to receive input information to perform an action; receiving a lock instruction from the first user, via the first GUI, and locking information associated with the selection; and disabling use of the locked information from the plurality of second users for a pre-set time period, wherein the first user is permitted to use the locked information during the pre-set time period.

The method may further include receiving a selection from one of the plurality of second users for selecting the locked information; and presenting a second GUI to the one of the plurality of second users, wherein the plurality of second users can view the locked information via the second GUI.

The method may further include wherein, in disabling use of the locked information, the plurality of second users are prevented from editing or updating the locked information.

The method may further include wherein the lock instruction is configured to lock at least one of the selection, one or more input information, and one or more action parameters displayed on the first GUI.

The method may further include wherein the lock instruction triggers a timer and the locked information automatically unlocks when the timer exceeds or is equal to the pre-set time period.

The method may further include wherein the lock instruction triggers a timer and a notification is sent to a system administrator when the timer exceeds a time threshold.

The method may further include receiving a request from one or more of the plurality of second users to unlock the locked information.

According to embodiments, an apparatus for enhancing social platform information processing, may include at least one memory configured to store program code; and at least one processor configured to read the program code and operate as instructed by the program code, the program code including first receiving code configured to cause the at least one processor to receive a selection from a first user for selecting social platform information extracted from a social platform, wherein the first user makes the selection before a plurality of second users; first presenting code configured to cause the at least one processor to present a first GUI to the first user, based on the selection, wherein the first GUI is configured to receive input information to perform an action; second receiving code configured to cause the at least one processor to receive a lock instruction from the first user, via the first GUI, and locking information associated with the selection; and disabling code configured to cause the at least one processor to disable use of the locked information from the plurality of users for a pre-set time period, wherein the first user is permitted to use the locked information during the pre-set time period.

The apparatus may further include third receiving code configured to cause the at least one processor to receive a selection from one of the plurality of second users for selecting the locked information; and second presenting code configured to cause the at least one processor to present a second GUI to the one of the plurality of second users, wherein the plurality of second users can view the locked information via the second GUI.

The apparatus may further include wherein, in disabling use of the locked information, the plurality of second users are prevented from editing or updating the locked information.

The apparatus may further include locking code configured to cause the at least one processor to, in response to the lock instruction, lock at least one of the selection, one or more input information, and one or more action parameters displayed on the first GUI.

The apparatus may further include unlocking code configured to cause the at least one processor to, in response to the lock instruction, trigger a timer and automatically unlock the locked information when the timer exceeds or is equal to the pre-set time period.

The apparatus may further include notification code configured to cause the at least one processor to, in response to the lock instruction, trigger a timer and send a notification to a system administrator when the timer exceeds a time threshold.

The apparatus may further include fourth receiving code configured to cause the at least one processor to receive a request from one or more of the plurality of second users to unlock the locked information.

According to example embodiments, a non-transitory computer-readable medium includes computer-executable instructions for enhancing social platform information processing by an apparatus, wherein the computer-executable instructions, when executed by at least one processor of the apparatus, cause the apparatus to receive a selection from a first user for selecting social platform information extracted from a social platform, wherein the first user makes the selection before a plurality of second users; present a first GUI to the first user, based on the selection, wherein the first GUI is configured to receive input information to perform an action; receive a lock instruction from the first user, via the first GUI, and locking information associated with the selection; and disable use of the locked information from the plurality of users for a pre-set time period, wherein the first user is permitted to use the locked information during the pre-set time period.

The non-transitory computer readable medium may further, when executed by at least one processor of the apparatus, cause the apparatus to receive a selection from one of the plurality of second users for selecting the locked information; and present a second GUI to the one of the plurality of second users, wherein the plurality of second users can view the locked information via the second GUI.

The non-transitory computer readable medium may further include wherein, in disabling use of the locked information, the plurality of second users are prevented from editing or updating the locked information.

The non-transitory computer readable medium may further, when executed by at least one processor of the apparatus, cause the apparatus to, in response to the lock instruction, lock at least one of the selection, one or more input information, and one or more action parameters displayed on the first GUI.

The non-transitory computer readable medium may further, when executed by at least one processor of the apparatus, cause the apparatus to, in response to the lock instruction, trigger a timer and at least one of (i) automatically unlocking the locked information when the timer exceeds or is equal to the pre-set time period, and (ii) sending a notification to a system administrator when the timer exceeds a time threshold.

The non-transitory computer readable medium may further, when executed by at least one processor of the apparatus, cause the apparatus to, receive a request from one or more of the plurality of second users to unlock the locked information.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a diagram of an example environment in which systems and/or methods, described herein, may be implemented;

FIG. 2 is a diagram of example components of a device according to an embodiment;

FIG. 3 is an exemplary diagram of a customer supporting system according to one or more embodiments;

FIG. 4 is an exemplary flowchart illustrating a method for enhancing social platform information processing according to one or more embodiments;

FIG. 5 is another exemplary flowchart illustrating a method for enhancing social platform information processing according to one or more embodiments;

FIG. 6 is a block diagram of an example of computer code for enhancing social platform information processing according to one or more embodiments;

FIG. 7 is a diagram illustrating an example GUI according to one or more embodiments; and

FIG. 8 is a diagram illustrating another example GUI according to one or more embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a method and system which allows a system user (e.g., system administrator of a service provider, a person in charge of a service associated with information from a social platform, a customer service agent, etc.) to lock/unlock a social platform information, while providing all users a transparent view of the information of the system user who is working on the social platform information.

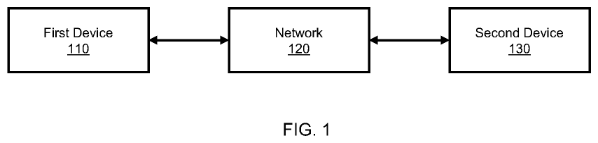

FIG. 1 is a diagram of a system according to an embodiment. FIG. 1 includes a first device 110, a network 120, and a second device 130. The first device 110 and the second device 130 may interconnect via wired connections, wireless connections, or a combination of wired and wireless connections.

The first device 110 may include user devices such as a computing device (e.g., a desktop computer, a laptop computer, a tablet computer, a handheld computer, a smart speaker, a server device, etc.), a mobile phone (e.g., a smart phone, a radiotelephone, etc.), a camera device, a wearable device (e.g., a pair of smart glasses or a smart watch), or a similar device.

The second device 130 may include one or more devices. For example, the second device 130 may be a server device, a computing device, or the like.

The network 120 may include one or more wired and/or wireless networks. For example, network 120 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) may perform one or more functions described as being performed by another set of devices.

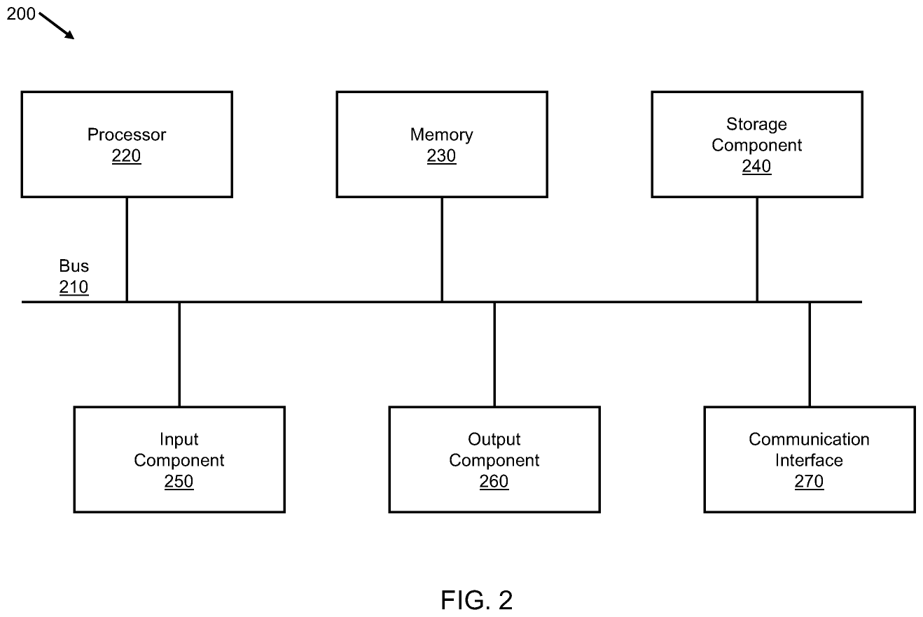

FIG. 2 is a diagram of components of one or more devices of FIG. 1 according to an embodiment. Device 200 may correspond to the first device 110 and/or the second device 130.

As shown in FIG. 2, the device 200 may include a bus 210, a processor 220, a memory 230, a storage component 240, an input component 250, an output component 260, and a communication interface 270.

The bus 210 may include a component that permits communication among the components of the device 200. The processor 220 may be implemented in hardware, software, or a combination of hardware and software. The processor 220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor 220 may include one or more processors capable of being programmed to perform a function.

The memory 230 may include a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 may store information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 may include a component that permits the device 200 to receive information, such as via user input (e.g., a touch screen display, a keyboard, a keypad, a mouse, a button, a switch, and/or a microphone). The input component 250 may include a sensor for sensing information (e.g., a global positioning system (GPS) component, an accelerometer, a gyroscope, and/or an actuator).

The output component 260 may include a component that provides output information from the device 200 (e.g., a display, a speaker, and/or one or more light-emitting diodes (LEDs)).

The communication interface 270 may include a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform operations based on the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or storage component 240 may cause the processor 220 to perform one or more processes described herein.

Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

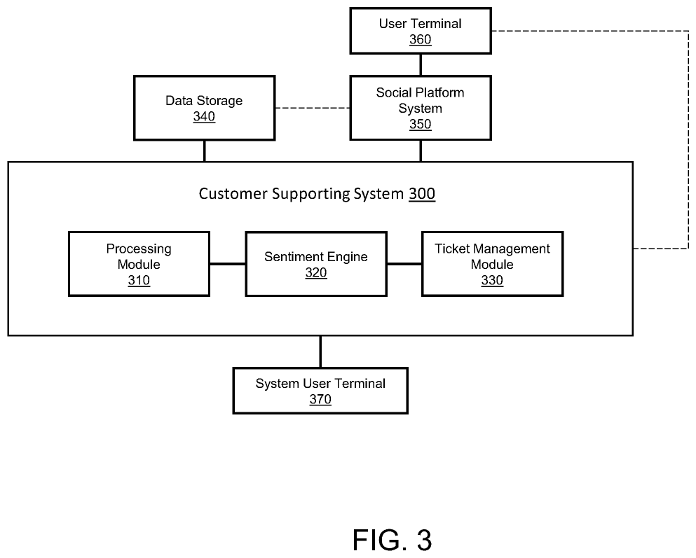

In embodiments, any one of the operations or processes of FIGS. 3-8 may be implemented by or using any one of the elements illustrated in FIGS. 1 and 2.

According to an example embodiment, information from a social platform may be processed in, for example, a customer supporting system. The customer supporting system may monitor and extract information from one or more social platforms. Subsequently, the information may be used to generate a ticket (or perform another action) relating to the extracted information from the one or more social platforms.

FIG. 3 is an exemplary diagram of a customer supporting system 300 according to an embodiment. The customer supporting system 300 may include a processing module 310, a sentiment engine 320, and a ticket management module 330. Components of the customer supporting system 300 may be implemented as software instructions executed, e.g., by at least one processor 220.

The customer supporting system 300 is include or be communicably connected to a data storage 340. Further, the customer supporting system 300 is communicably connected to a social platform system 350, e.g., via a network such as the Internet. The social platform system 350 may include one or more social platforms.

The end user accesses the social platform system 350 via a user terminal 360 and posts information on a social platform. The social platform may be included in or deployed by the social platform system 350. The processing module 310 continuously (or periodically) monitors the information (e.g., post, live feed, comments, etc.) available on a social platform and determines which information is of interest. The information available on the social platform may be retrieved from the social platform system 350. For example, the centralized processing module 310 may search or monitor at least one of a particular page or section of the social platform (e.g., one or more pages, sites corresponding to a service provider or entity to which the customer supporting system 300 belongs or in-charge of monitoring, etc.). The monitoring may be based on one or more predetermined keywords (e.g., a name of the service provider or entity, nicknames for the entity, a field/category of service related to the service provider or entity, etc.), one or more predetermined mentions (e.g., account belonging to the service provider or entity), one or more hashtag keywords, etc.

The system user accesses the customer supporting system 300 via a system user terminal 370 and, for example, sets the predetermined keyword(s) that the system user wants to monitor the social platform for. Additionally or alternatively, the system user may also set predetermined keyword(s) that are to be excluded from the monitoring. The configuration of the predefined keyword(s) set by the system user is stored in a data storage 340 in, for example, a keyword configuration profile. The system user is able to select one or more keyword configuration profiles for monitoring the social platform. Based on the selected one or more keyword configuration profiles, the processing module 310 monitors the information and determines whether or not the monitored information contains any information that may be related to the predetermined keyword(s) according to the selected one or more keyword configuration profiles. The processing module 310 then extracts the related information (e.g., extract text directly from comments, extract information in audio and/or video feed which may be converted to a text description file and extract the text therefrom, etc.) from the social platform (e.g., the post, comment, review, etc.). Subsequently, the extracted information is provided to the sentiment engine 320.

The sentiment engine 320 processes the extracted information to determine (e.g., via a keyword matching method) a sentiment value associated with the extracted information. In some embodiments, the sentiment value represents the sentiment level of the extracted information or the total sentiment value of the entire information (e.g., the entire post/comment). The sentiment value may represent a sentiment category in which the information falls under. That is, the sentiment engine 320 determines whether the information is recognized as a positive, a negative, or a neutral sentiment based on the sentiment value and then categorizes the information as such. The determination results and the categories may be provided to the processing module 310.

Based on the information from the sentiment engine 320, the processing module 310 may automatically trigger the ticket management module 330 (e.g., if the information is determined to have a negative sentiment, etc.) to generate and present a ticket creation GUI to the system user to allow the system user to create a ticket to be handled by a system user. In some embodiments, the ticket creation GUI includes a plurality of input fields to receive inputs from the system user for specifying the ticket. The ticket creation GUI may also include a graphical representation area (e.g., a list, a post portion, etc.) showing at least a portion of the extracted information (e.g., portion a post which is determined to contain negative information, etc.) and showing the information required for creating a ticket (e.g., the sentiment category, a location of the post or user, etc.) so as to allow the system user to easily and clearly create a ticket based thereon. In some embodiments, the processing module 310 may trigger the ticket management module 330 to automatically generate a ticket, in response to the extracted information falling under the negative sentiment category. The ticket may be generated and presented to the system user on a GUI to enable review and editing via the system user terminal 370.

In some embodiments, it is possible that multiple tickets are generated at the same time. The multiple tickets may be generated from the same social platform or different social platforms in the social platform system 350. In some embodiments, the ticket management module 330 may generate and present the ticket creation GUI to the system user to allow the system user to create a ticket for the social platform information determined as positive or neutral information.

Embodiments of the present disclosure are not limited to automatic presentation of the ticket creation GUI. In another example embodiment, the system user is notified of the extracted information and/or the sentiment category, and the system user manually creates the ticket(s). For example, if it is determined that the extracted information falls under the negative sentiment category, the processing module 310 may trigger a message (e.g., in the form of email, SMS, push notification, etc.) to notify the system user that negative information has been posted on a social platform and investigation of the post is required. The notification is not limited to this and may include other messages and details of the post (e.g., at least one of an identifier of the social platform in the social platform system the user posted the comment on, the keywords found in the comment, the sentiment value determined to be associated with the post, time stamp of the post, other related posts by the same end user that include related information/keywords, etc.). Subsequently, a ticket to be handled by a system user may be generated and presented by the customer supporting system 300 via, for example, the ticket creation GUI provided by the ticket management module 330.

The ticket will be assigned by the system user (via the ticket creation GUI) to an appropriate handler. The handler/ticket assignee will then review the ticket and determined whether or not it is required to interact with the end user who raised the issue or made the post/comment. If it is determined that it is required to interact with the end user who raised the information, the system user may communicate with the end user via, for example, a GUI. The system user may also interact with the end user through the system user terminal 370. For example, the system user may use a GUI displayed on the system user terminal 370 to send a direct message to the end user, reply to the post/comment, etc. The end user may receive and respond to commination from the system user through the user terminal 360 via the social platform system 250. The system user terminal 370 and the user terminal 360 may correspond to, for example, the user device 110 of FIG. 2 or device 200 of FIG. 2.

The data from the customer supporting system 300 (i.e., the extracted information from the processing module 310, the sentiment values and the sentiment categories from the sentiment engine 320) may be stored in the data storage 340. The data storage 340 may be internal or external to the customer supporting system 300 and may be similar to or different from the storage component 240 of FIG. 2. In some embodiments, data storage 240 includes multiple data storages.

As shown in FIG. 3, the processing module 310 is communicatively coupled to the sentiment engine 320 and the ticket management system module 330 via, for example, an API gateway. It is understood, however, that one or more other embodiments are not limited to this configuration. Some modules may be combined or separated into separate modules. For example, the processing module 310 may function as both the processing module 310 and as the sentiment engine 320. The customer supporting system 300 may be communicatively coupled to one or more system user terminals (e.g., system user terminal 370) and may be communicatively coupled to one or more user terminals (e.g., user terminal 360). The social platform system 350 may also be communicatively coupled to one or more user terminals (e.g., user terminal 360). The data storage 340 may also be communicatively coupled to the customer supporting system 300 and the social platform system 350.

When the system user starts working on the extracted information (e.g., when the system user is in the process of creating a ticket associated with one or more of the information extracted by the processing module 310 from the social platform), the system user may choose to lock the extracted information (e.g., by clicking on a “lock” function) via the ticket creation GUI. Locking the extracted information will prevent other system users from working on the same social platform information at the same time. Thus, duplicated work is avoided.

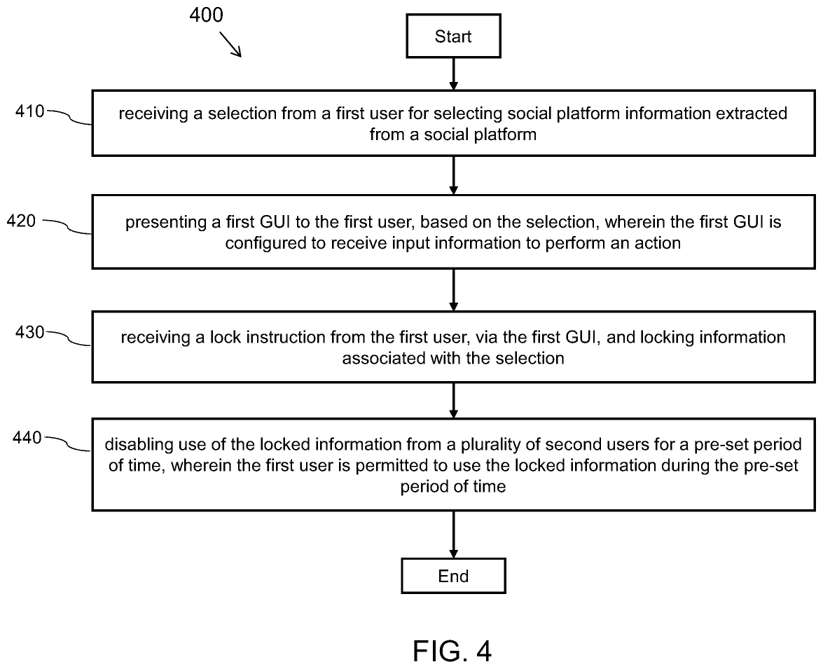

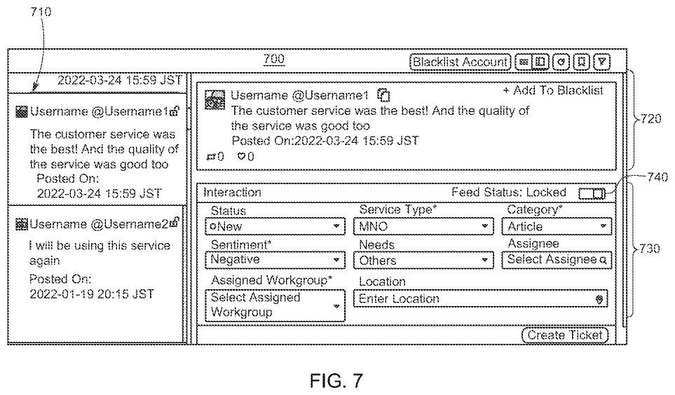

FIG. 4 is an exemplary flowchart illustrating a method 400 for social platform information processing using the locking feature when a system user is selecting to work on unlocked information (from the extracted information), according to an embodiment. The method 400 of FIG. 4 may be performed by, for example, the customer supporting system 300. First, information is extracted from the social platform and presented to the system user (e.g., displayed on the system user terminal 370). The extracted social platform information may be displayed to the system user in, for example, a list as shown in FIG. 7 (i.e., the information list 710). The extracted information (hereafter “social platform information”) may then further be used to perform an action, such as creating a ticket.

The system user may make a selection for selecting the social platform information. Descriptions of FIG. 4 assume that the information being selected is unlocked information. As shown in FIG. 4, at operation 410, the selection is received from a first user for the social platform information extracted from the social platform. In some embodiments, the selection may be for at least one or more of the social platform information displayed. The first user is a user who has selected unlocked information.

In response to the selection, at operation 420, a first GUI is presented to the system user based on the selection. The first GUI includes input fields and is configured to receive input information to perform the action. The input information may be, for example, used to fill out or update ticket parameters for ticket creation, system user comments, etc. One or more of the input fields may require the first user to manually fill the input fields. One or more of the input fields may be auto filled upon presentation of the first GUI. The auto filled fields may be editable by the system user.

At operation 430, via the first GUI, a lock instruction may be received from the first user. The lock instruction may, by default, lock all the information associated with the selection. That is, lock the extracted social platform information corresponding to the selection and the ticket parameters used for performing the ticket creation. In some embodiments, the system user may be presented with another GUI wherein the system user is able to specify what information will be locked. For example, the extracted social platform information (e.g., the post 720 shown in FIG. 7) corresponding to the selection, and/or one or more of the ticket parameters displayed on the first GUI, etc. According to embodiments, locked information refers to the information being locked either as instructed by the system user or by the systems default (e.g., a default setting, which may be updated or set by the system user(s) or admin user(s))

At operation 440, after receiving the lock instruction, second users (i.e., other system users with access to the service/system) are disabled from using or working on the locked information for a pre-set time period. The pre-set time period is intended to provide the first user adequate time to complete the ticket creation or finish working on the selected extracted social platform information. The information may automatically be unlocked after a pre-set time period has elapsed. In some embodiments, instead of automatically unlocking the information, a notification may be sent to a system admin wherein the system admin can decide whether to, for example, extend the time in which the information is locked, re-set the time period, unlock the information, contact the first user who locked the information, etc. Embodiments are not limited to this. The notification may also be sent to the first user or both the first user and the system admin. In another example embodiment, the notification may be sent at a time threshold that is set, for example, for a time before the pre-set time period. Thus, for example, based on the notification being sent before the automatic unlocking of the information, the system admin or the first user may take the necessary steps to complete the action before the information is unlocked.

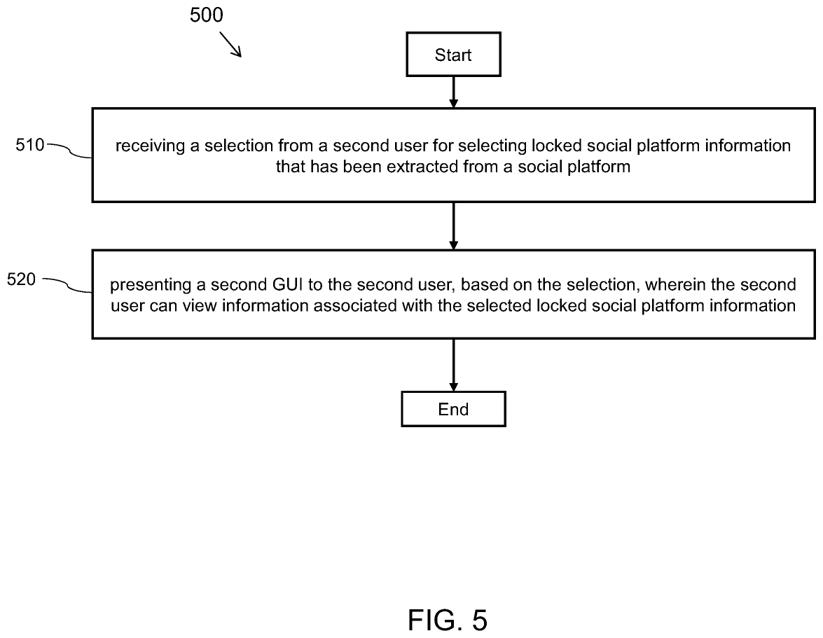

FIG. 5 is an exemplary flowchart illustrating a method 500 for social platform information processing using the locking feature when a system user is selecting locked information (from the extracted information), according to an embodiment. Similar to the method 400, the method 500 of FIG. 5 may be performed by, for example, the customer supporting system 300. As previously described, information is extracted from the social platform and presented to the system user (e.g., displayed on the system user terminal 370). The extracted social platform information may be displayed to the system user in, for example, a list as shown in FIG. 7 (i.e., the information list 710). The extracted information (hereafter “social platform information”) may then further be used to perform an action, such as creating a ticket.

As shown in FIG. 5, at operation 510, a selection is received from the second users (i.e., one or more of the second users) for selecting social platform information extracted from the social platform that has been locked by, for example, the first user.

In response to the selection, at operation 520, a second GUI is presented to the second users based on the selection. The second GUI displays the input fields, the selected social platform information, system user comments, etc., similar to the first GUI. However, based on the lock instruction associated with the selected locked social platform information (i.e., what information is locked), one or more of the input fields may be configured not to receive input information. Further, the selected social platform information (e.g., the post 720 as shown in FIG. 7), system user comments, etc., may also be locked (i.e., disabled from editing, updating, etc.). Accordingly, in contrast to the first user using the first GUI, the second users can only view the locked information (as well as information that may not be locked) via the second GUI but do not have access to change/update the locked information.

Although FIGS. 4 and 5 show example operations of methods, in some implementations, the methods may include additional operations, fewer operations, different operations, or differently arranged operations than those depicted in FIGS. 4 and 5. Additionally, or alternatively, two or more of the operations of the methods may be performed in parallel or combined.

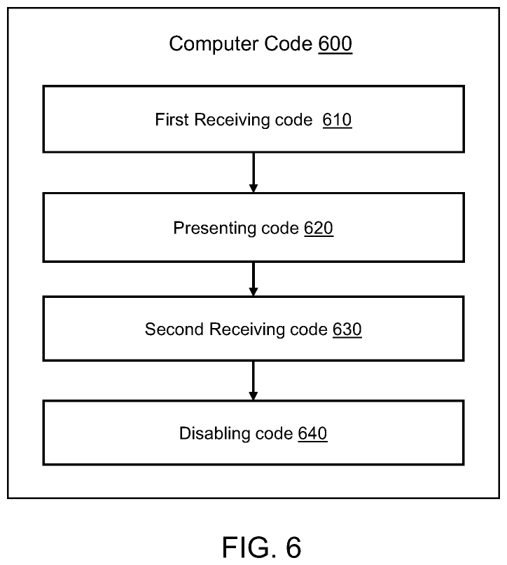

FIG. 6 is a block diagram of an example of computer code for social platform information processing using the locking/unlocking feature, according to one or more embodiments. According to embodiments of the present disclosure, at least one processor with memory storing computer code of an apparatus/device/system may be provided. The computer code may be configured to, when executed by the at least one processor, perform any number of aspects of the present disclosure.

As shown in FIG. 6, the computer code 600 may include first receiving code 610, presenting code 620, second receiving code 630, and disabling code 640.

The first receiving code 610 may be configured to cause the at least one processor to receive a selection from a first user for selecting social platform information extracted from a social platform, wherein the first user makes the selection before a plurality of second users.

The presenting code 620 may be configured to cause the at least one processor to present a first GUI to the first user, based on the selection, wherein the first GUI is configured to receive input information to perform an action.

The second receiving code 630 may be configured to cause the at least one processor to receive a lock instruction from the first user, via the first GUI, and locking information associated with the selection.

The disabling code 640 may be configured to cause the at least one processor to disable use of the locked information from the plurality of second users for a pre-set time period, wherein the first user is permitted to use the locked information during the pre-set time period.

Although FIG. 6 shows example blocks of the computer code 600 of the apparatus/device/system according to embodiments, in some implementations, the apparatus/device/system may include additional blocks, fewer blocks, different blocks, or differently arranged blocks than those depicted in FIG. 6. Additionally, or alternatively, two or more of the blocks of the apparatus/device/system may be combined. In other words, while FIG. 6 shows distinct blocks of code, the various code instructions need not be distinct and could be intermingled.

FIG. 7 is an example illustration of a ticket creation GUI 700 for creating a ticket and locking social platform information which is being utilized for the ticket creation, according to an embodiment. The ticket creation GUI 700 may correspond to the first GUI described with reference to the method 400. Information may be at least one of a post, live feed, comments, etc., extracted from the social platform. The ticket creation GUI 700 is displayed to a system user of, for example, a service, an application, or the like where multiple system users have access to the information extracted from the social platform. As shown in FIG. 7, the ticket creation GUI 700 may include a dashboard containing an information list 710, a post 720, and an interaction portion 730.

The information list 710 is a list/view of information extracted from the social platform such as, for example, a full post, full comments, information on the end user (such as a username, location, etc.). In some embodiments, the information list 710 may be customized or filtered by the system user to include information based on keyword(s), regions, user groups, and/or any other suitable factors for categorizing/filtering the information. The post 720 is a post (or other information) selected from the information list 710. The interaction portion 730 includes a plurality of input windows to allow the system user to view and edit ticket parameters which may be required for creating a ticket.

When the information is extracted from the social platform and displayed to the system user (e.g., the information list 710), the system user may need to work on the information or use the information to perform an action (e.g., create a ticket, contact an end user associated with the information, etc.). The system user may select one of the information from the information list 710 to work on. The selected information may be displayed on the ticket creation GUI 700. For example, as shown in FIG. 7, the post 720 is selected and displayed to the system user. The post 720 includes the full post made by an end user, the end user's username (i.e., User1), the date and time in which the post was made. In some embodiments, the post 720 may include a hyperlink (i.e., an external link) to the post to be viewed on the web and/or the social platform.

The system user may lock the information while working on the post 720. For example, once information is selected from the information list 710, if the system user wants to prevent other system users from working on the same information, a lock function on the selected post 720 may be triggered by performing a locking action such as clicking on a dedicated icon (e.g., a padlock icon presented on the information in the information list 710, etc.) The system user may want to lock information when, for example, the system user is creating a ticket and/or editing ticket parameters associated with the post 720 in order to ensure that other system users are aware that the post 720 is being worked on by the system user. Similarly, the system user who locked the information may perform the same or different action (as performed to lock the information) to unlock the information.

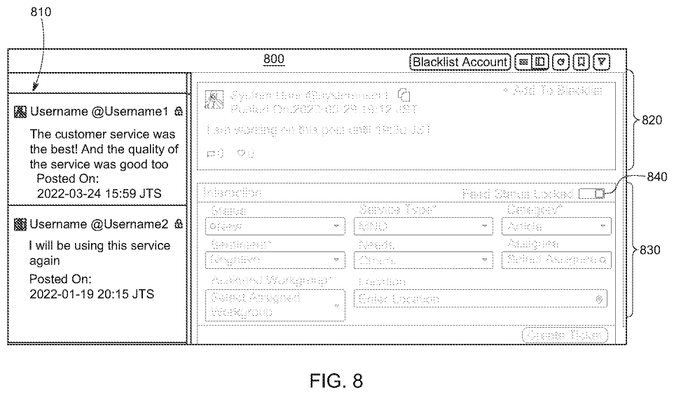

In some embodiments, the system user may also perform the locking action by selecting a functional element (e.g., a button, switch, etc.) in the interaction portion 730. For example, the ticket creation GUI 700 may include a lock status 740. The lock status 740 of the selected information may be, for example, locked and unlocked. The lock status 740 may be paired with the functional element to allow for changes and/or updates to the lock status. In FIG. 7, the lock status 740 of the ticket creation GUI 700 is “Unlocked” and the function element may be selected to switch the lock status to, for example, “Locked” as shown in FIG. 8. One or more of the methods for locking/unlocking information may be used according to embodiments.

Once the information is locked, other users will not be able to work on the same information. The information of the system user who is locking (or has locked) the information will also be presented in the ticket creation GUI 700.

FIG. 8 is an example of the ticket creation GUI 800 displayed to other system users for locked information. That is, an example displays the ticket creation GUI 800 when a system user selects information from the information list 710 that is locked by another system user.

As shown in FIG. 8, if the other system users select locked information, the system user's information (i.e., the system user who locked the information) will be shown at the top portion of the ticket creation GUI 800. The system user's information may include at least one of a system user name, a system user email, when the post was locked (e.g., time and date), lock duration (i.e., how long the information has been locked), etc. Thus, all other system users are able to know that a particular social platform information is locked, which system user locked it, etc. Similar to the ticket creation GUI 700 displayed in response to the selection of unlocked information, the ticket creation GUI 800 may still include at least one of the selected information (e.g., the post 720), details of the selected information such as ticket parameters (e.g., the interaction portion 730), comments/notes made by the system user regarding the information, etc. However, the information will be locked and unavailable for editing by other system users. The ticket creation GUI 800 may be visually distinguishable to a system user from the ticket creation GUI 700. For example, as shown in FIG. 8, the ticket creation GUI 800 may be grayed out (indicating that the elements and input fields in the GUI are disabled). Although, the elements and input fields are disabled (i.e., the GUI is locked), other system users are still able to view the information. However, they may not be able to edit or update the ticket until the information is unlocked.

Embodiments are not limited to locking/unlocking the entire action of ticket creation, as shown in FIG. 8. In some embodiments, the system may also lock/unlock a sub-action (i.e., one or more input field and/or ticket parameters in the ticket creation GUI, etc.)

In one or more embodiments, the other system users may unlock information that has been locked by the system user. That is, a second system user can unlock a first post that was locked by a first system user. If unlocking of a locked information is required, the other system users may contact the system user (that has locked the information) to unlock this particular social platform information (e.g., if they are from a different team and would like to work on the same social platform information for a different reason, etc.) The other system users may contact the system user through the ticket creation GUI 800 in the form of email, push notification, direct message, etc. In some embodiments, the other system users may make an unlock request to a system admin (e.g., by double clicking on the locked elements or an interactive element such as button 840, a request form will be presented as a pop-up, new window/GUI, etc., that allows the system user to make a request to the system admin). Subsequently, the system admin can unlock the information on a case-by-case basis (i.e., after reviewing the request and the situation).

The unlocking of information according to embodiments is not limited to a process performed by the system user who locked the information (hereafter “original system user”) and/or the system admin. In some embodiments, the system may auto-unlock locked information. For example, the system auto-unlocks a post upon detecting that the original system user has log-out from the system. In another example, after a period of time, the system will present a pop-up, window, or the like, to request the original system user to extend the locking period. If the system user does not reply within, for example, 3 minutes (which implies that the system user may not actively be working on the post), the system will automatically unlock the information.

In one or more embodiments, once the system user starts locking information (i.e., by performing the locking action), a timer will be triggered. The timer tracks the time duration of time of locking (i.e., how long the information is locked). If the timer reaches and/or exceeds a pre-set time threshold (e.g., 10 minutes after the locking action) and the information is remained locked, a notification (e.g., email, SMS, push notification, etc.) is sent to the system admin. Accordingly, the system admin can check the status of the action performing by the system user (e.g., creation of ticket) and decide whether or not to unlock the information to allow other system users to access to the information. The pre-set time threshold may be set by the system admin based on, for example, an average time for performing the action (e.g., creating a ticket), etc. In some embodiments, the system may adjust/set the time threshold. For example, the system will continuously record the timing of ticket creation, continuously update an average ticket creation time, and continuously/periodically update the time threshold.

According to the above description, when information (e.g., the post 720) is locked, other system users will not be able to work on the locked information. Further, when information (e.g., the post 720) is unlocked, the other users will be able to work on the unlocked information. Embodiments are not limited to this. In some embodiments, the system may allow for a partial lock or unlock of the information. That is, for example, only lock or unlock the post 720 to some specific system users and/or system user groups. During locking/unlocking the information (e.g., by pressing the padlock icon), a GUI may be presented to the system user to allow the system user to select target system users/system user groups to whom the information will be locked/unlocked.

FIGS. 7 and 8 are merely examples for explaining a use case of an action begin performed (i.e., creating a ticket). The action is not limited to this and may be any suitable action not explicitly mentioned herein. Additionally, the information may be relating to a generated ticket, an assigned ticket, and/or any of the information extracted by the processing module 310 from the social platform system 350. The information (i.e., social platform information) may be any suitable information and is not limited to social platform information.

Embodiments relating to unlocking and locking social platform information that is in use for performing some action, as described herein, provides a system which can prevent redundant work, while maintaining transparency (e.g., all users can see who is locking and working on the information) and flexibility (e.g., users will have control on the action of locking/unlocking, instead of deciding by the system). Specifically, by locking social platform information, other system users will not be able to perform the same work, system efficiency is improved, other system users may also use locked information for their benefit (e.g., performing and completing another action), etc. The system of embodiments also implements precautions to prevent information from being locked by a system user for an extended or unreasonable amount of time. Therefore, if a system user is unable to handle or complete the action, another system user may handle or complete the action after, for example, a pre-set time has elapsed.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method for enhancing social platform information processing, performed by at least one processor and comprising:
receiving a selection from a first user for selecting social platform information extracted from a social platform, wherein the first user makes the selection before a plurality of second users;
presenting a first GUI to the first user, based on the selection, wherein the first GUI is configured to receive input information to perform an action;
receiving a lock instruction from the first user, via the first GUI, and locking information associated with the selection; and
disabling use of the locked information from the plurality of second users for a pre-set time period, wherein the first user is permitted to use the locked information during the pre-set time period.

2. The method of claim 1, further comprising:
receiving a selection from one of the plurality of second users for selecting the locked information; and
presenting a second GUI to the one of the plurality of second users, wherein the plurality of second users can view the locked information via the second GUI.

3. The method of claim 1, wherein, in disabling use of the locked information, the plurality of second users are prevented from editing or updating the locked information.

4. The method of claim 1, wherein the lock instruction is configured to lock at least one of the selection, one or more input information, and one or more action parameters displayed on the first GUI.

5. The method of claim 1, wherein the lock instruction triggers a timer and the locked information automatically unlocks when the timer exceeds or is equal to the pre-set time period.

6. The method of claim 1, wherein the lock instruction triggers a timer and a notification is sent to a system administrator when the timer exceeds a time threshold.

7. The method of claim 1, further comprising receiving a request from one or more of the plurality of second users to unlock the locked information.

8. An apparatus for enhancing social platform information processing, comprising:
at least one memory configured to store program code; and
at least one processor configured to read the program code and operate as instructed by the program code, the program code including:
first receiving code configured to cause the at least one processor to receive a selection from a first user for selecting social platform information extracted from a social platform, wherein the first user makes the selection before a plurality of second users;
first presenting code configured to cause the at least one processor to present a first GUI to the first user, based on the selection, wherein the first GUI is configured to receive input information to perform an action;
second receiving code configured to cause the at least one processor to receive a lock instruction from the first user, via the first GUI, and locking information associated with the selection; and
disabling code configured to cause the at least one processor to disable use of the locked information from the plurality of second users for a pre-set time period, wherein the first user permitted to use the locked information during the pre-set time period.

9. The apparatus of claim 8, the program code further comprising:
third receiving code configured to cause the at least one processor to receive a selection from one of the plurality of second users for selecting the locked information; and
second presenting code configured to cause the at least one processor to present a second GUI to the one of the plurality of second users, wherein the plurality of second users can view the locked information via the second GUI.

10. The apparatus of claim 8, wherein, in disabling use of the locked information, the plurality of second users are prevented from editing or updating the locked information.

11. The apparatus of claim 8, the program code further comprising:
locking code configured to cause the at least one processor to, in response to the lock instruction, lock at least one of the selection, one or more input information, and one or more action parameters displayed on the first GUI.

12. The apparatus of claim 8, the program code further comprising:
unlocking code configured to cause the at least one processor to, in response to the lock instruction, trigger a timer and automatically unlock the locked information when the timer exceeds or is equal to the pre-set time period.

13. The apparatus of claim 8, the program code further comprising:
notification code configured to cause the at least one processor to, in response to the lock instruction, trigger a timer and send a notification to a system administrator when the timer exceeds a time threshold.

14. The apparatus of claim 8, the program code further comprising fourth receiving code configured to cause the at least one processor to receive a request from one or more of the plurality of second users to unlock the locked information.

15. A non-transitory computer readable medium storing instructions, the instructions comprising: one or more instructions that, when executed by at least one processor of an apparatus for enhancing social platform information processing storing instructions that, cause the at least one processor to:
receive a selection from a first user for selecting social platform information extracted from a social platform, wherein the first user makes the selection before a plurality of second users;
present a first GUI to the first user, based on the selection, wherein the first GUI is configured to receive input information to perform an action;
receive a lock instruction from the first user, via the first GUI, and locking information associated with the selection; and
disable use of the locked information from the plurality of second users for a pre-set time period, wherein the first user is permitted to use the locked information during the pre-set time period.

16. The non-transitory computer readable medium of claim 15, wherein the instructions further cause the at least one processor to:
receive a selection from one of the plurality of second users for selecting the locked information; and
present a second GUI to the one of the plurality of second users, wherein the plurality of second users can view the locked information via the second GUI.

17. The non-transitory computer readable medium of claim 15, wherein, in disabling use of the locked information, the plurality of second users are prevented from editing or updating the locked information.

18. The non-transitory computer readable medium of claim 15, wherein the instructions further cause the at least one processor to, in response to the lock instruction, lock at least one of the selection, one or more input information, and one or more action parameters displayed on the first GUI.

19. The non-transitory computer readable medium of claim 15, wherein the instructions further cause the at least one processor to, in response to the lock instruction, trigger a timer and at least one of (i) automatically unlocking the locked information when the timer exceeds or is equal to the pre-set time period, and (ii) sending a notification to a system administrator when the timer exceeds a time threshold.

20. The non-transitory computer readable medium of claim 15, wherein the instructions further cause the at least one processor to receive a request from one or more of the plurality of second users to unlock the locked information.
